(19) United States
(12) Patent Application Publication
(10) Pub. No.: US 2014/0053887 A1
(43) Pub. Date: Feb. 27, 2014

(54) Handle Actuated Length-Adjustable Cane

(71) Applicant: Lanny Ray Lee, Port Saint Lucie, FL (US)

(72) Inventor: Lanny Ray Lee, Port Saint Lucie, FL (US)

(21) Appl. No.: 13/900,021

(22) Filed: May 22, 2013

Related U.S. Application Data
(60) Provisional application No. 61/689,309, filed on Jun. 4, 2012.

(51) Int. Cl. A45B 9/04; A45B 3/00; A61H 3/02; A45B 9/00

(52) U.S. Cl. CPC A45B 9/04; A45B 9/00; A45B 3/00; A61H 3/02
USPC 135/66; 135/75; 135/69; 135/71

(57) ABSTRACT

A length adjustable cane for assisting a user with mobility on surfaces having different heights includes a cylindrical outer tube and a cylindrical core member configured to be received in the outer tube and telescopically movable between retracted and extended configurations relative thereto. A handle is connected to an upper end of the core member. An actuator lever is coupled to the handle and accessible to a hand of the user, the actuator lever being movable between actuated and released configurations. A latching mechanism is situated in the outer tube proximate the open end thereof. A drawbar having an elongate configuration is positioned in an interior of the core member. The drawbar includes a first end coupled to the actuator lever and a second end operatively coupled to the latching mechanism. Operation of the actuator lever operates the latching mechanism to selectively allow length adjustment of the cane.

### REFERENCE TO RELATED APPLICATION

This non-provisional patent application claims the benefit of provisional application Ser. No. 61/689,309 filed on Jun. 4, 2012, titled Walking Cane Length Controlled from Handle to Reduce Steps Hazard.

### BACKGROUND OF THE INVENTION

The most commonly used mobility aide is the walking cane. While it is recognized that a walking cane can be used for decorative purposes and/or as a fashion accessory, the majority of cane structures are specifically designed to be used as an aide to physically challenged individuals not requiring full time use of a wheelchair or walker assembly. However, when needed, a cane assembly should include sufficient structural integrity to allow an individual to stand or walk over a variety of different surfaces in a safe, reliable, and stable manner.

It is well recognized that walking canes, walking sticks, and like devices have been in use for thousands of years and as such typically comprise a one piece elongated shaft having some type of handle or hand gripping portion secured to one end thereof. However, recently there has been an increased demand for a cane structure which is more structurally versatile. For example, there is a recognized need for a walking cane assembly to overcome any disadvantages and problems associated with known or conventional canes, such as by being at least partially collapsible or foldable into a reduced volume configuration. Such capabilities would allow the storage and transport of a cane assembly more easily and/or in a smaller area. At the same time, any structurally modified and operationally versatile walking cane assembly should be reliably stable and used to aide in the support or mobility of a physically challenged individual. However, the providing of such stability should not detract from the preferred lightweight structure of a walking cane.

While walking canes are tremendously helpful in assisting the physically impaired, there are a number of hazards associated with their use. Specifically, the basic design of a walking cane belies the fact that employing such a walking aid can actually cause additional problems for the user if the cane is not carefully selected for the individual user. A cane that is too short causes the user to lean to the side, and can lead to a strain on a user back. If a cane is too long or too ‘high’, it causes the user elbow to bend too much, making the arm work harder from a disadvantaged position. As canes are rigid, it is important to select a cane that fits the specific height requirements of an individual to minimize the amount of impact that is transferred to the user each time the cane is placed on the ground. This is best noted by the tapping of a cane user walking along a hard floor.

Accordingly, a need remains for an adjustable cane that overcomes the above-noted risks.

No prior art addresses the hazard users face when transitioning ramps, steps or simple curbs whether transitioning up or down. Generally said, more effort is being spent by cane makers to sell canes based on price and color schemes and stylish heads. Often makers use a friction/elastic nut to as an adjuster mechanism. This friction squeeze locational device should not be used in prosthetics as it is not a failsafe locating means. In addition, off center cam devices are unreliable as they too can fail when the parts fail because of wear and natural degrading of resilient components. Friction should never be relied up as a device.

### BRIEF SUMMARY OF THE INVENTION

The present invention is a walking cane that is adjustable “on the fly” as is needed to adapt to walking over varying terrain and structures. User dress changes and shoe heel height change as well overall physical conditions vary that require length changes to adapt to stride changes. Also the walking cane precise length is critical as the user transitions from other prosthetics or mobility devices. Further hand and wrist shock is decreased with a dampening by the use of Bellville dish washers in the tip cap.

The telescopic adjusting mechanism is actuated by a user applying a downward pressure to the handle, compressing a deformable resilient spring-member along the longitudinal length of the shaft, transferring the downward pressure to the shaft, and forcing the core member down into the cavity. An incremental adjustment is augmented by screwing the core to achieve an infinitely variable length adjustment. Further reduction of harmful shock to the user arm and hand when using the cane is achieved by adjusting to a precise length of a walking cane. A forearm support is provided to serve as an arm crutch.

Releasing the telescoping mechanism is accomplished by rotating a finger operated control forward by which the operator overcomes the spring resistance of a spring in the release mechanism and allows the jaws to be pulled inward. The cane is then able to be latched by releasing the finger control, thus engaging the normally latched condition. To provide a more positive control especially when the finger or thumb is slippery, toothed ribs are provided as a means for positive user control.

Therefore, an object of the present invention is to provide a length adjustable cane in which the cane shaft may be telescopically adjusted “on the fly.” The present invention satisfies such a need by providing an apparatus that is convenient and easy to use, is lightweight yet durable in design, and assists a user of different heights to comfortably employ a cane while walking or standing. A user having orthopedic requirements needs a much more fine adjustment length than is provided by incremental holes with detent devices.

The presently disclosed cane affords greater locomotion control, and eases the shock to the user arm and hand that results from repeated striking of the cane against a hard surface during varied surface walking conditions. The cane's precision adjustability alleviates back and joint pain associated with rigid, ill-fitting walking canes, and the physical assistance provided by the cane serves to give the user a psychological boost as well.

The present invention is simple to use, inexpensive, and designed for many years of use. In the case of a weakened or arthritic hand where grip is failing, means are provided by the prior art to provide a platform at the base of the cane. These easily create a fall hazard for others largely because the platform feet extend away from the user's body in a surprising way.

These and other objects, features, and advantages of the invention are provided by an adjustable-length cane for assisting a user of different heights to comfortably deploy the cane to a desired length while walking or standing. Another advantage to the adjustable cane is that it may be retracted to chair arm height. This allows a user to rise from a chair or sofa unassisted. If the user has fallen often they are able get into a chair by retracting the cane and using it to get to their knees and then standing or getting into a chair without assistance.

Other features preferably associated with the newly proposed walking cane assembly should be the ability to easily and efficiently adjust its overall length in order to accommodate users of various sizes. Also when a preferred cane assembly incorporates a collapsible or foldable feature, specific structural components should be associated therewith which serve to stabilize at least the elongated shaft portion of the cane when being disposed and maintained in an operative, ready to use position.

Further, as the trauma of surgery or injury abates it is important that the user become less dependent on support from cane or crutch. The adjustable-length cane or crutch may be lengthened or shortened to “wean” the user. Another advantage to the adjustable-length cane is to provide support as the user's needs change daily. Even within a day the needs change as when the user needs a little extra support after a physical therapy treatment session. The residual damage to the spine thru prolonged cane use is well known.

The present invention is further made unique in the grip. Prior art depends on the friction of the grip for control by essentially applying a bicycle handlebar grip to a cane. The prior art has ignored that the power of the opposed thumb is the last remaining power of the hand. That is the ability to pinch down on a grip to retain it in the palm to bear the pressure all the while resisting the torque. Thus, a generally cylindrical gripping surface used for wrapping one's fingers largely provides pull away protection and with little friction available for radial control; hence, the forefinger presses along the shaft.

To provide an ergonomical grip the grip includes a general center axis that is angled at approximately 17° to the centerline of the tubular shaft. This provides a cane or crutch with an ergonomically correct grip angle. Support is maintained by the forward portion of the hand away from the heel to relieve the wrist strain. Another advantage is the pinch grooves which provide a means to control the cane by giving a mechanical pinch gripping that the cane user is able to continue using the cane even after their fingers no longer have strength or, worse, one or more fingers are missing.

The shape of the grip gives the user's hand a flatter top surface to rest against while being pressed by thumb. This relieves ulnar neuropathy (numbness of the fourth and fifth fingers) over time to become permanent hand injury.

This invention, when the grip has been reconfigured, may include a mounting configuration such as a camera mount, video camera mount, instrument mount, shooting support and when used in plural as a bipod and tripod.

In another embodiment of the invention, crutch users must deal with the problem of storage of the crutch when using, traveling, and doing everyday tasks. Often, they fall and require the assistance of others. Also, crutches are difficult and impractical to adjust for special needs on a daily basis. Most crutches have a handgrip that is horizontal which is harmful to the hands and wrist unless the cane is a temporary aid. The needs of a crutch user may vary because of heavy clothing and type of shoes. To deal with this the lower portion is adjustable as with the cane and having a similar grip. The underarm pad to grip is easily adjustable by a lathing mechanism similar to the lower portion. The upper portion of the cane is able to be folded 180° to enable the user to use the cane when the user is able to move in limited walking situations. To further the user's convenience the upper and lower portions of the crutch may be shortened so when folded and shortened may be easily stored when traveling.

Further to the aspect of a safer cane is solved by a renewable spike to transition slippery surfaces and converting the handle and lengthen the cane to provide a ski pole having a wrist strap withdrawn from the stowed position. Used in pairs this walking cane makes it possible for the user to traverse surfaces heretofore impassible.

### BRIEF DESCRIPTION OF THE DRAWINGS

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a side view of a length-adjustable cane according to a preferred embodiment of the present invention illustrated in a retracted configuration upon on schematically rendered staircase;

FIG. 2 is a side view of the cane as in FIG. 1 illustrated in a normal use length configuration;

FIG. 3 is a side view of the cane as in FIG. 1 illustrated in an extended configuration;

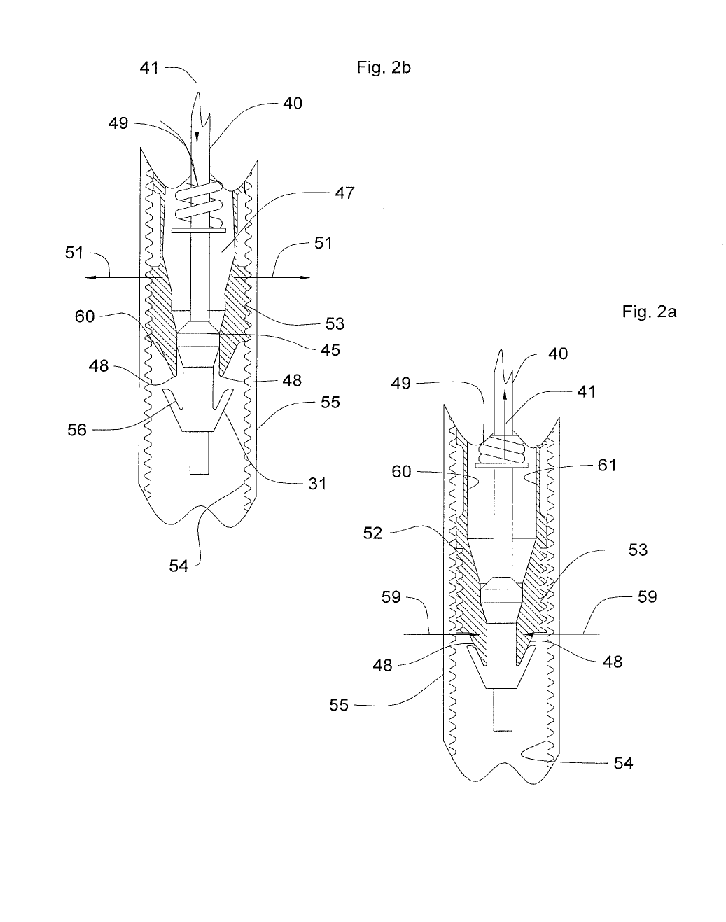

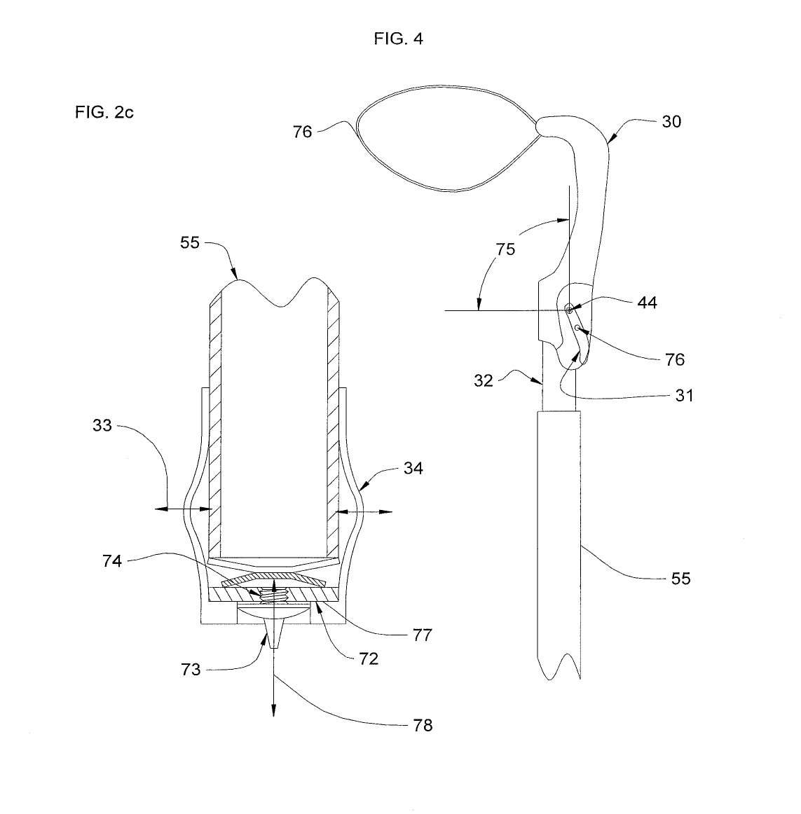

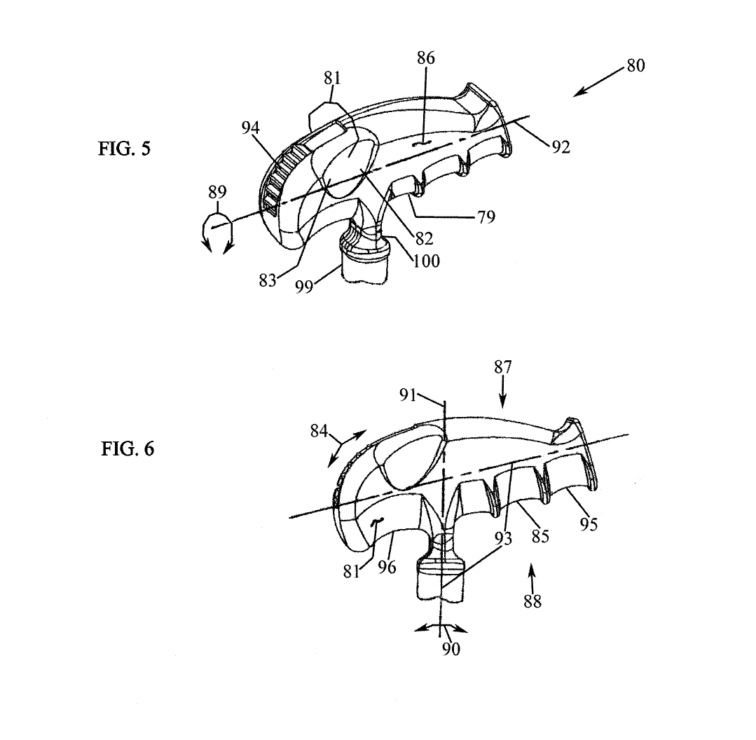

FIG. 2a is a sectional view of an adjuster mechanism of present invention in retracted position to provide clearance to adjust;

FIG. 2b is a sectional view of the adjuster mechanism of present invention in extended position to a latched mode;

FIG. 2c is a sectional view of a tip mechanism of present invention;

FIG. 4 is a side view of present invention showing handle position for improved gripping and with wrist strap withdrawn;

FIG. 5 is a perspective view of a grip showing an adjuster mechanism of the present invention;

FIG. 6 is a side view of a grip showing angle an adjuster mechanism of the present invention;

FIG. 7a is a front view of a crutch attachment to the cane according to one embodiment of the present invention;

FIG. 7b is a side view of the crutch attachment as in FIG. 7a;

FIG. 7c is another side view of the crutch attachment at a folded configuration;

FIG. 7d is another side view of the crutch attachment at folded and retracted configuration;

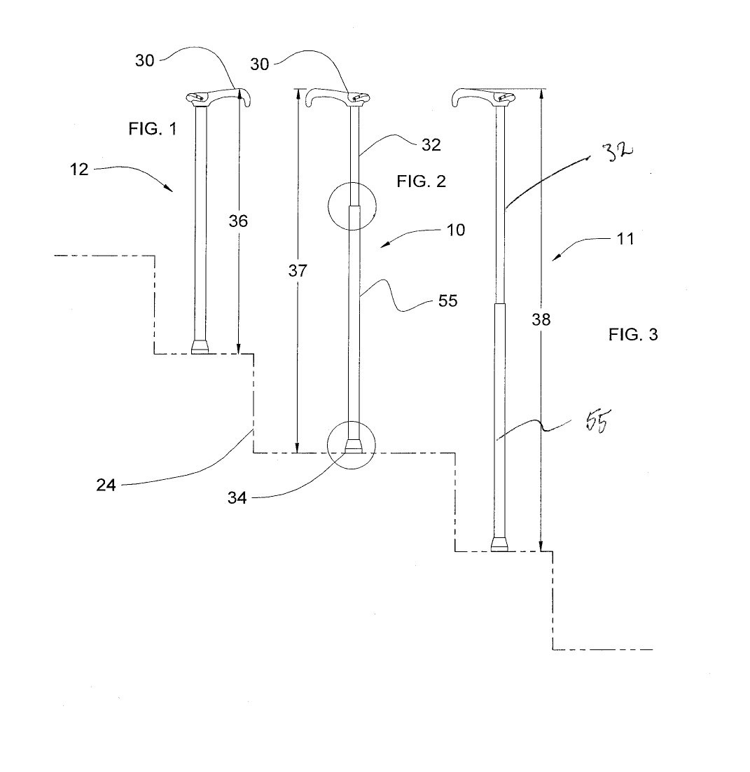

FIG. 8 is a side view of a grip of the cane of FIG. 1 showing a latching mechanism engaged;

FIG. 8a is an isolated view taken from FIG. 8; and

FIG. 9 is a side view of a cane showing the latch disengaged.

### DESCRIPTION OF THE PREFERRED EMBODIMENT

A length-adjustable cane according to a preferred embodiment of the present invention will now be described with reference to FIGS. 1 to 8 of the accompanying drawings. The cane 10 includes a telescopic handle, a handle 30, and a tip 34.

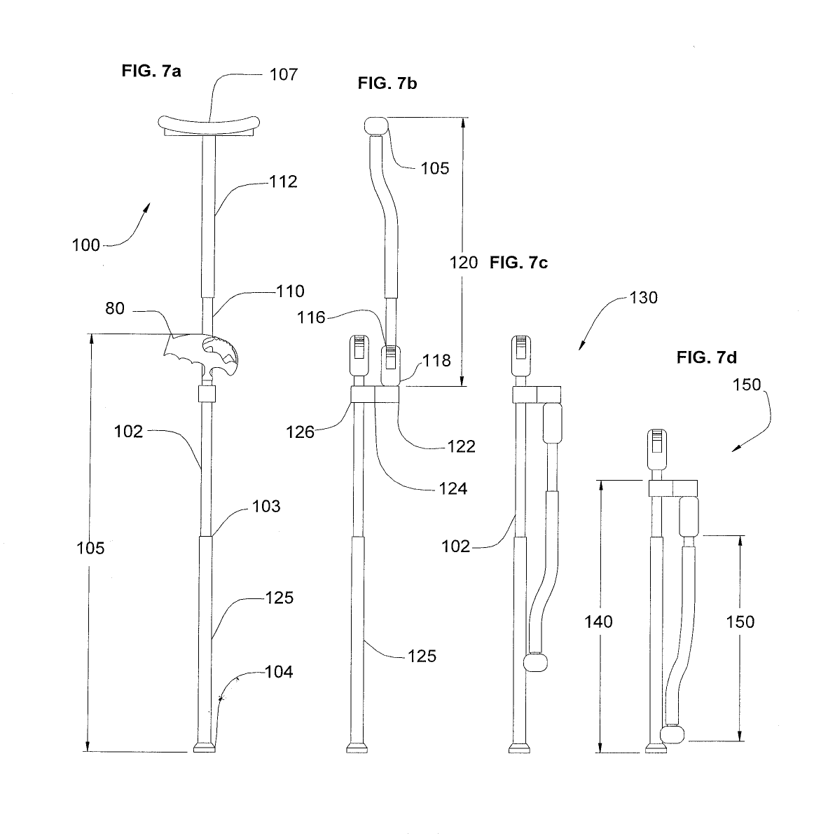

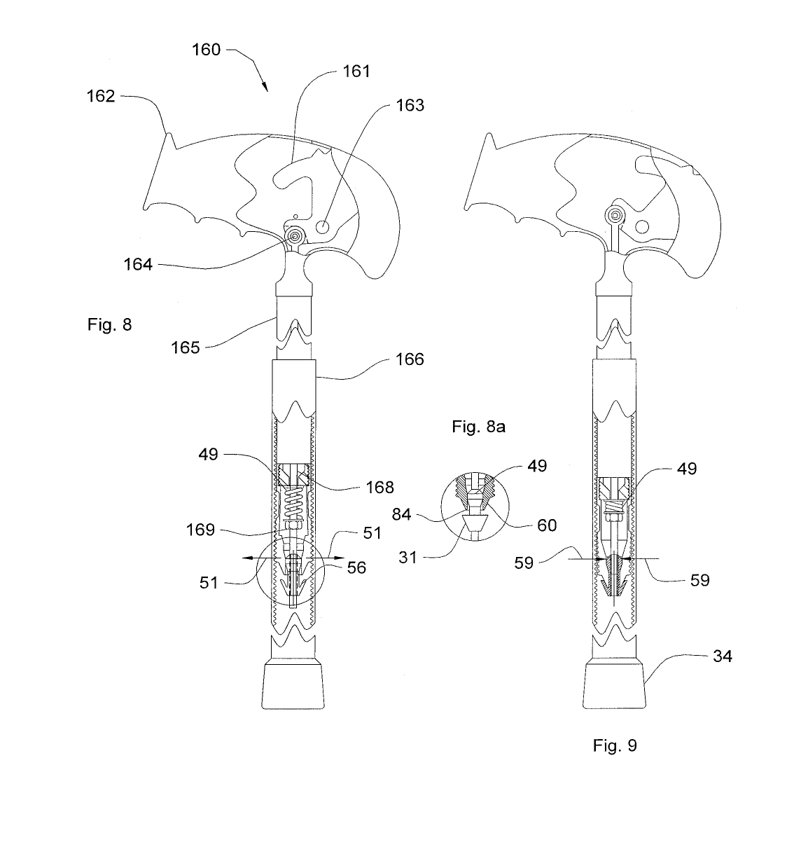

The length adjustable cane 10 includes an outer tube 55 having a generally cylindrical configuration that defines an interior area. The interior area may also be referred to as a cavity 47. The length adjustable cane 10 also includes a core member 32 having a generally cylindrical configuration that is complementary to the cylindrical configuration of the outer tube 55 but such that the core member 32 may be received into the interior area of the outer tube 55. The core member 32 is movable between a retracted configuration substantially inside the interior area of the outer tube 55 and an extended configuration substantially outside the interior area of the outer tube 55. It is understood that the core member 32 may be situated at an almost infinitely variable number of positions between the retracted and extended configurations according to the latching mechanism described later. Therefore, the adjustable cane 10 is telescopically adjustable. A nominal (or normal) length cane 10 and shortened/retracted cane 12 is shown as being lengthened cane 11. A cane 10 is shown at a normal or nominal length configuration (FIG. 2). A cane 12 is shown at a retracted configuration (FIG. 1) and a cane 11 is shown at an extended configuration (FIG. 3).

The length adjustable cane 10 includes a handle 30 connected to an upper end of the core member 32. Handle 30 of shown in FIG. 2 conditions of extension remain at users optimal height as tip 34 of FIG. 1 is placed on climbing representative stair tread 24. While FIG. 3 demonstrates at a walking height FIG. 3 is placed below a walking level on a lower tread 24. Thus an optimal hand level is achieved at most walking tasks so that the user body continues to remain upright.

An actuator lever 31 is coupled to the handle 30 and is accessible to a hand of a user. The actuator lever 31 is pivotally movable between an actuated configuration and a released configuration by the manipulation of a user's finger or palm. Operation of the actuator lever 31 will enable telescopic portions of the cane shaft to be adjusted or secured as will be described in more detail below. In FIG. 4, actuating lever 31 is located in handle 30 and operatively coupled to the core member 32. The actuating lever 31 is accessible to the user's finger or palm, actuation of which releases core member 32 to be compressed from a nominal length 37 (FIG. 2) to length 36 (FIG. 1) or relaxed to extend to length 38 (FIG. 3). The core member 32 is positioned in tube member 55 and configured to move slidably between extended and retracted configurations relative thereto.

A drawbar 40 is coupled to the actuating lever 31 with a pin 44 and extends downwardly and internally through the core member 32 and is operatively coupled to a latching mechanism that is situated in the interior area of the outer tube 55. At a desired length actuating lever 31 is released causing drawbar 40 to be spring 49 driven by kinetic energy in direction 41 to return to a free state of engage in direction 51. More particularly, the latching mechanism is configured to selectively allow the core member 32 to move toward its retracted configuration inside the outer tube 55 when the actuation lever 31 is at the actuated configuration and a compressive/downward pressure is imparted upon the handle by the user. This corresponds to a situation where the user actuates the lever and then presses down on the can to decrease its length. Conversely, if the actuation lever 31 is actuated and no downward pressure is imparted, a compression spring operatively coupled to the core member 32 urges the core member 32 to move upwardly toward the extended configuration. This corresponds to a situation where the user desires to extend the length of the length adjustable cane 10.

The drawbar 40 includes a bulge 45 such that the cane is in a latched state in close fit to opening 46 of external helix latch 53 and having jaw 48 detent in a normally engaged direction 51 by holding engagement by bulge 55. Releasing external helix 52 from internal thread 54 of outer tube 55 biased by compression spring 49 opposed jaws 48 are allowed to flex as part of external helix latch 53 and are located to distil end of core 32. Thus an un-latched condition is accomplished by external helical rib 53 being withdrawn from internal helix 54 of tube member 55 causing movement 59 as cone 60 provides ramp for cup 56.

FIG. 2c shows a sectional view of tip 34 showing annular bulge boot 34 flexing 33 a slight interference fit to a closed end of outer tube 55 and having a rigid washer 72 having a threaded center 74 to receive a removably attached cleat 73, bonded to inside bottom surface 77 of boot 34. A series of disk washers are in communication with distal end of outer tube 55 and upper surface of stiff washer 72 making a dampener excursion 78 tip.

FIG. 4 is shows handle 30 in a rotated position 75. Wrist strap 76 is shown withdrawn from stowage within handle 30.

FIG. 5 is a perspective view of an ergonomic grip 80 having pinch grooves 81 positioned to receive the upper thumb and finger alternatively of a person's hand. Pinch grooves 81 having a front wall 83 and rear wall 82 provide a mechanical connection between a portion of preferably index finger communicating with palm flat 86 and a portion of an opposed thumb. It is understood that this grip configuration makes gripping less reliant on the friction of wrapped fingers. The grip defines index finger groove 96, middle finger groove 79, ring finger groove 85 and baby finger groove 95. Principal force vectors as in any mechanical connection to a hand are expressed in the drawings as arrows such that load 87 is opposed by normally negligible pull away force 88, leaving the finger grooves as measurable increased friction areas 81 bordered by ribs 85. Torque vector 89 and another vector are but acting radial in nature. Torque is controlled by the unreliable friction of fingers but mostly by the mechanical pinch 81. Pitch and yaw 90 shown in FIG. 7 as natural to shaft 91 at approximate shown as natural angle 17° designated 93 and axis 92 of grip. Provided for stability, thin stem 100 is provided to comfortably wrap index finger reducing the need to control the torque 89 with the index finger as conventionally parallel to shaft 99. Thus grip 80 is less reliant on friction for control.

Yet another embodiment of the invention is the crutch 100 configurations shown in FIGS. 7a, 7b, 7c and 7d. This embodiment includes grip 80, outer tube 103, telescoping inner tube 102, and tip 104. Actuator 106 provides latching to vary height 105. Underarm pad 107 is connected to upper outer tube 112 and upper inner tube 110 slidably telescopes to outer tube 112 and similarly upper actuator 116 within housing 116 latches to length 120. Housing 116 is pivotally connected to pivot block 122 at annular bearing surface 124 and configured to move between folded and deployed configurations. A pivotal interface 126 includes a first portions connected to the core member 32 of the cane 125 (FIG. 7b) and a second portion pivotally coupled to the first portion. The second portion is selectively coupled to the crutch 130 such that the crutch 130 may be extended upwardly or folded downwardly. As shown in FIGS. 7c and 7d, the crutch 130 may be both folded and collapsed/retracted.

FIG. 8 reveals finger latch 161 pivots 163 and linked with pintle 164 terminating drawbar 40 and when rotated draws drawbar 40 and compresses spring 49. When finger latch 161 is released, the drawbar 40 is pulled in direction 41.

1. A length adjustable cane for assisting a user with mobility on surfaces having different heights, comprising:
an outer tube having a generally cylindrical configuration that defines an interior area and an open upper end;
a core member having a generally hollow cylindrical configuration complementary to said cylindrical configuration of said outer tube, said core member being received in said interior area of said outer tube and selectively movable between a retracted configuration substantially inside said outer tube interior area and an extended configuration substantially outside said outer tube interior area;
a handle connected to an upper end of said core member;
an actuator lever coupled to said handle and accessible to a hand of the user, said actuator lever being movable between actuated and released configurations;
a latching mechanism situated in said outer tube proximate said open end of said outer tube; and
a drawbar positioned in an interior of said core member and having an elongate configuration, said drawbar having a first end coupled to said actuator lever and a second end operatively coupled to said latching mechanism;
wherein said latching mechanism is configured to selectively allow said core member to move toward said retracted configuration when said actuation lever is at said actuated configuration a compressive force is imparted upon said handle by the user.

2. The length-adjustable cane as in claim 1, wherein:
said latching mechanism includes a compression spring operatively coupled to said core member; and
said latching mechanism is configured to cause said compression spring to urge said core member toward said extended configuration when said actuation lever is at said actuated configuration and no compression force is imparted on said handle.

3. The length-adjustable cane as in claim 1, wherein said handle includes an graspable portion having an ergonomic configuration, said graspable portion defining a plurality of grooves that provide a pinch groove to provide mechanical connection between an opposed thumb and forefinger of the user.

4. The length-adjustable cane as in claim 3, wherein said graspable portion is in operative communication with said actuator member.

5. The length-adjustable cane as in claim 1, comprising a tip coupled to a closed lower end of said outer tube, said tip configured to reduce shock to the user's arm and hand.

6. The length-adjustable cane as in claim 5, wherein said tip includes a compression spring configured to absorb impact forces.

7. The length-adjustable cane as in claim 5, comprising a cleat removably coupled to a lower surface of said tip, said cleat having an axis generally parallel to an axis of defined by said outer tube.

8. The length-adjustable cane as in claim 1, comprising a stowable wrist strap housed within said graspable portion of said handle.

9. The length-adjustable cane as in claim 1, comprising an accessory configured to support one of a camera, a video device, a magnifying device, or a night vision device.

10. The length-adjustable cane as in claim 1, comprising:
an interface having a first portion removably coupled to said upper end of said core member and a second portion pivotally coupled to said first portion; and
a crutch coupled to said second portion of said interface such that said crutch is selectively movable between an upwardly extended configuration and a folded configuration.

11. The length-adjustable cane as in claim 10, wherein said crutch is a forearm crutch.
